(19) United States
(12) Patent Application Publication
(10) Pub. No.: US 2019/0105893 A1
(43) Pub. Date: Apr. 11, 2019

(54) SYSTEM AND METHOD FOR RAPID PRESS CHANGEOVER WITH SENSED INK CHARACTERISTIC

(71) Applicant: Baldwin Americas Corporation, St. Louis, MO (US)

(72) Inventors: Matthew Keith Hendricks, Sussex, WI (US); Mark McKnight, Sussex, WI (US); Gary Stumvoll, Sussex, WI (US)

(73) Assignee: Baldwin Americas Corporation, St. Louis, MO (US)

(21) Appl. No.: 16/081,785

(22) PCT Filed: Mar. 3, 2017
(86) PCT No.: PCT/US2017/020772

§ 371 Date: Aug. 31, 2018

Related U.S. Application Data
(60) Provisional application No. 62/303,440, filed on Mar. 4, 2016.

(51) Int. Cl. B41F 31/02

(52) U.S. Cl. CPC B41F 31/027; B41F 31/08; B41F 31/022

(57) ABSTRACT

A decorator press for printing on metal cans has a pump unit, a distribution head, a sensing device and a processing circuit. The pump unit comprises a plurality of inlet ports, a first inlet port configured to receive an ink of a first color from a first ink source and a second inlet port configured to receive an ink of a second color darker than the first color. The distribution head is coupled to the pump unit and configured to spread fluid received from the pump unit across zones of a print roller. The sensing device is coupled to the press and configured to sense a characteristic of fluid flowing out of the distribution head. The processing circuit is configured to receive the sensed characteristic, compare the sensed characteristic to a predetermined threshold, and to provide an indication to a display based on the comparison.

### CROSS REFERENCE TO RELATED APPLICATIONS

This application claims priority to and the benefit of U.S. Patent Application No. 62/303,440, filed Mar. 4, 2016, which is incorporated herein by reference in its entirety.

### BACKGROUND

The present application relates generally to printing presses and more specifically to systems and methods for changing inks in a printing press.

In one system described in U.S. Pat. No. 5,967,044 to Marschke, a printer uses a pressurized supply of cleaning solution and a common ink and cleaning solution conduit connecting the ink supply and the cleaning solution supply to the ink chamber. A controller may be operative to provide a selected cycle of alternating operation of the supply of cleaning solution and pressurization of the ink chamber to move cleaning solution into and out of said chamber.

### SUMMARY

Some embodiments of the present application relate to a method of changing inks in a printing press. The printing press includes a pump unit having a plurality of ports and a distribution head. The method includes passing an ink of a first color from a first port on the pump unit through the pump unit and through the distribution head. The method further includes coupling a fluid source having a fluid to a second port on the pump unit, wherein the fluid includes an ink of a second color. The method further includes disabling the flow of ink of the first color through the pump unit and distribution head. The method further includes passing the fluid through the pump unit and distribution head. The method further includes sensing a characteristic of fluid passing out of the distribution head using a sensing device. The method further includes comparing the sensed characteristic to a predetermined threshold. The method further includes providing an indication on a display based on the comparison.

In some embodiments, the ink of the second color is darker than the first color. In some embodiments, the ink of the second color is the same color as the first color.

In some embodiments, after providing an indication on a display based on the comparison, the method further includes receiving a user input. The user input may be provided by a user viewing the display, through a user device including the display. For example, the user device may be a desktop, laptop, or mobile device, and the display may be a screen on the user device. The user input may be provided via, for example, a touch on a touchscreen, a keyboard, a mouse, or any other selectable button on the user device. The user input relates to an approval of the user to, for example, begin a printing operation. In some embodiments, the method includes initiating the printing operation (e.g., via generating and/or transmitting one or more control signals to a control system of the printing press) in response to the input. In some embodiments, the printing operation includes the application of the ink of the second color.

In some embodiments, after comparing the sensed characteristic to a predetermined threshold, the method includes changing the ink in the printing press. For example, if the sensed characteristic is over the predetermined threshold, it is determined that the printing press may, for example, begin a new printing operation. In some embodiments, the printing operation includes the application of the ink of the second color.

In some embodiments, after comparing the sensed characteristic to a predetermined threshold, the method includes both changing the ink in the printing press and providing an indication on a display based on the comparison.

In some embodiments, the printing press is a decorator press for printing on metal cans. The pump unit of the decorator press is configured for positive displacement pumping of fluids and has at least four separate positive displacement pumps. The distribution head of the decorator press includes at least four separate distribution ports, each distribution port configured to source fluid from a corresponding positive displacement pump to different zones of a roller on the printing press.

In some embodiments, the printing press may be any type of web offset press, sheet fed press, non-offset presses such as gravure presses, newspaper presses, or the like. The pump unit of the printing press is configured for positive displacement pumping of fluids. The pump unit has at least four separate positive displacement pumps. The distribution head includes at least four separate distribution ports, each distribution port configured to source fluid from a corresponding positive displacement pump to different zones of a roller on the printing press.

In some embodiments, the pump unit may include any number of separate positive displacement pumps, and the distribution head may include any number of distribution ports.

In some embodiments, the sensing device includes a viscosity sensor coupled to the printing press. The viscosity sensor senses the viscosity of the fluid which is used as the sensed characteristic compared to the predetermined threshold.

In some embodiments, the sensing device is a color sensor configured to sense a color of the fluid passing out of the distribution head. The comparing step indicates if the fluid passing out of the distribution head meets a predetermined color threshold. The indication of the comparison is provided on the display.

In some embodiments, the predetermined color threshold is stored in CIE L*a*b* color space. In some embodiments, the predetermined color threshold may be stored in any of a number of color spaces, such as CIELUV color space, RGB, CMYK, sRGB, or the like.

In some embodiments, the sensing device is a light sensor configured to sense a reflectivity of the fluid passing out of the distribution head. The comparing step indicates if the reflectivity of the fluid meets a predetermined threshold. The indication of the comparison is provided on the display.

In some embodiments, the pump unit and distribution head each include a separate housing coupled together with tubing.

In some embodiments, the plurality of ports are disposed on a manifold portion of the pump unit.

In some embodiments, the first color and the second color are the same color. The sensing device is a ink level sensing device configured to sense the levels of the first ink in a tank. The sensed characteristics is the level of the first ink in the tank. The comparison includes comparing the level of the first ink in the tank to a predetermined threshold.

In some embodiments, an indication of the level of first ink in the tank is provided on the display. In some embodiments, the printing press is configured to switch from the first ink to a second ink, of the same color as the first ink, from a second tank when the level of the first ink in the first ink has reached the predetermined threshold.

Some embodiments of the present disclosure relate to a decorator press for printing on metal cans. The decorator press includes a pump unit comprising a plurality of inlet ports, a first inlet port configured to receive an ink of a first color from a first ink source and a second inlet port configured to receive an ink of a second color. The decorator press further includes a distribution head coupled to the pump unit and configured to spread fluid received from the pump unit across zones of a print roller. The decorator press further includes a sensing device coupled to the press and configured to sense a characteristic of fluid flowing out of the distribution head. The decorator press further includes a processing circuit configured to receive the sensed characteristic, compare the sensed characteristic to a predetermined threshold, and to provide an indication to a display based on the comparison.

In some embodiments, the ink of the second color is darker than the first color. In some embodiments, the ink of the second color is the same color as the first color.

In some embodiments, the pump unit is configured for positive displacement pumping of fluids. The pump unit has at least four separate positive displacement pumps. The distribution head includes at least four separate distribution ports, each distribution port configured to source fluid from a corresponding positive displacement pump to a different zone of a roller on the printing press.

In some embodiments, the pump unit may include any number of separate positive displacement pumps, and the distribution head may include any number of distribution ports.

In some embodiments, the sensing device includes a viscosity sensor coupled to the printing press. The viscosity sensor senses the viscosity of the fluid which is used as the sensed characteristic compared to the predetermined threshold.

In some embodiments, the sensing device is a color sensor configured to sense a color of the fluid passing out of the distribution head. The comparing step indicates if the fluid passing out of the distribution head meets a predetermined color threshold. The indication of the comparison is provided on the display.

In some embodiments, the predetermined color threshold is stored in CIE L*a*b* color space. In some embodiments, the predetermined color threshold may be stored in any of a number of color spaces, such as CIELUV color space, RGB, CMYK, sRGB, or the like.

In some embodiments, the sensing device is a light sensor configured to sense a reflectivity of the fluid passing out of the distribution head. The comparing step indicates if the reflectivity of the fluid meets a predetermined threshold. The indication of the comparison is provided on the display.

In some embodiments, the pump unit and distribution head each include a separate housing coupled together with tubing.

In some embodiments, the plurality of ports are disposed on a manifold portion of the pump unit.

In some embodiments, the first color and the second color are the same color. The sensing device is a ink level sensing device configured to sense the levels of the first ink in a tank. The sensed characteristics is the level of the first ink in the tank. The comparison includes comparing the level of the first ink in the tank to a predetermined threshold.

In some embodiments, an indication of the level of first ink in the tank is provided on the display. In some embodiments, the printing press is configured to switch from the first ink to a second ink, of the same color as the first ink, from a second tank when the level of the first ink in the first ink has reached the predetermined threshold.

Some embodiments of the present application relate to a method of changing inks in a printing press. The printing press includes a pump unit having a plurality of ports and a distribution head. The method includes passing an ink of a first color from a first port on the pump unit through the pump unit and through the distribution head. The method further includes coupling a fluid source having a fluid to a second port on the pump unit, wherein the fluid includes an ink of a second color. The method further includes disabling the flow of ink of the first color through the pump unit and distribution head. The method further includes passing the fluid through the pump unit and distribution head. The method further includes sensing a characteristic of fluid passing out of the distribution head using a sensing device. The method further includes comparing the sensed characteristic to a predetermined threshold.

Some embodiments of the present disclosure relate to a printing press. The printing press includes a pump unit comprising a plurality of inlet ports, a first inlet port configured to receive an ink of a first color from a first ink source and a second inlet port configured to receive an ink of a second color. The printing press further includes a distribution head coupled to the pump unit and configured to spread fluid received from the pump unit across zones of a print roller. The printing press further includes a sensing device coupled to the press and configured to sense a characteristic of fluid flowing out of the distribution head. The decorator press further includes a processing circuit configured to receive the sensed characteristic and compare the sensed characteristic to a predetermined threshold.

In some embodiments of the above method and printing press, the ink of the second color is darker than the first color. In some embodiments, the ink of the second color is the same color as the first color.

In some embodiments of the above method and printing press, after comparing the sensed characteristic to a predetermined threshold, the method includes changing the ink in the printing press. For example, if the sensed characteristic is over the predetermined threshold, it is determined that the printing press may, for example, begin a new printing operation. In some embodiments, the printing operation includes the application of the ink of the second color.

In some embodiments of the above method and printing press, the printing press is a decorator press for printing on metal cans. The pump unit of the decorator press is configured for positive displacement pumping of fluids and has at least four separate positive displacement pumps. The distribution head of the decorator press includes at least four separate distribution ports, each distribution port configured to source fluid from a corresponding positive displacement pump to different zones of a roller on the printing press.

In some embodiments of the above method and printing press, the printing press may be any type of web offset press, sheet fed press, non-offset presses such as gravure presses, newspaper presses, or the like. The pump unit of the printing press is configured for positive displacement pumping of fluids. The pump unit has at least four separate positive displacement pumps. The distribution head includes at least four separate distribution ports, each distribution port configured to source fluid from a corresponding positive displacement pump to different zones of a roller on the printing press.

In some embodiments of the above method and printing press, the pump unit may include any number of separate positive displacement pumps, and the distribution head may include any number of distribution ports.

In some embodiments of the above method and printing press, the sensing device includes a viscosity sensor coupled to the printing press. The viscosity sensor senses the viscosity of the fluid which is used as the sensed characteristic compared to the predetermined threshold.

In some embodiments of the above method and printing press, the sensing device is a color sensor configured to sense a color of the fluid passing out of the distribution head. The comparing step indicates if the fluid passing out of the distribution head meets a predetermined color threshold.

In some embodiments of the above method and printing press, the predetermined color threshold is stored in CIE L*a*b* color space. In some embodiments, the predetermined color threshold may be stored in any of a number of color spaces, such as CIELUV color space, RGB, CMYK, sRGB, or the like.

In some embodiments of the above method and printing press, the sensing device is a light sensor configured to sense a reflectivity of the fluid passing out of the distribution head. The comparing step indicates if the reflectivity of the fluid meets a predetermined threshold.

In some embodiments of the above method and printing press, the pump unit and distribution head each include a separate housing coupled together with tubing.

In some embodiments of the above method and printing press, the plurality of ports are disposed on a manifold portion of the pump unit.

In some embodiments of the above method and printing press, the first color and the second color are the same color. The sensing device is a ink level sensing device configured to sense the levels of the first ink in a tank. The sensed characteristics is the level of the first ink in the tank. The comparison includes comparing the level of the first ink in the tank to a predetermined threshold.

In some embodiments of the above method and printing press, an indication of the comparison of the sensed characteristic to a predetermined threshold is provided on a display. In some embodiments, a user input can be received from a user viewing the display, through a user device including the display. For example, the user device may be a desktop, laptop, or mobile device, and the display may be a screen on the user device. The user input may be provided via, for example, a touch on a touchscreen, a keyboard, a mouse, or any other selectable button on the user device.

In some embodiments, the user input relates to an approval of the user to, for example, begin a printing operation. In some embodiments, the printing operation is initiated (e.g., via generating and/or transmitting one or more control signals to a control system of the printing press) in response to the input. In some embodiments, the printing operation includes the application of the ink of the second color.

In some embodiments, the printing operation is initiated (e.g., via generating and/or transmitting one or more control signals to a control system of the printing press) in response to the comparison of the sensed characteristic to the predetermined threshold. In some such embodiments, the printing operation may be initiated automatically in response to the comparison (e.g., without input from a user). An indication of the comparison and of the initiation of the printing operation can be provided on a display.

One or more embodiments described herein may provide for rapid changeover of a printing press from a first ink to a second ink of a different color.

One or more embodiments described herein may provide for a rapid changeover of a printing press from a first ink having a lighter color to a second ink having a darker color.

One or more embodiments described herein may provide for rapid cleaning of a printing press to remove ink of a first color with a cleaning solution.

One or more embodiments may allow a press operator to attach or couple a second ink source (or a third ink source, fourth ink source, etc.) to a press while it is still running with the first ink, in order to reduce press downtime during a color change.

One or more embodiments may provide a fluid collection device configured to collect fluids such as inks, cleaners, etc. from a distribution head for recycling or disposal.

### BRIEF DESCRIPTION OF THE DRAWINGS

FIG. 1 is a block diagram of a printing press, according to an illustrative embodiment;

FIG. 2 is a flowchart of a method of changing inks in a printing press, according to an illustrative embodiment;

FIG. 3 is a side elevational view, partly diagrammatic in character, and showing a digital inking system, according to an illustrative embodiment;

FIG. 4 is a vertical sectional view of one injector of a distribution head, according to an illustrative embodiment;

FIG. 5 is a view taken along lines 3-3 of FIG. 4 and showing several of the ink patterns made by the ink distributors, according to an illustrative embodiment;

FIG. 6A is a perspective view of a pump unit, according to an alternative embodiment;

FIG. 6B is an exploded perspective view of the pump unit of FIG. 6A;

FIG. 6C is another exploded perspective of the pump unit of FIG. 6C;

FIG. 7A is a perspective view of a frame assembly for inking a roller, according to an illustrative embodiment; and

FIG. 7B is an exploded view of a distribution head showing a blade, according to an exemplary embodiment.

### DETAILED DESCRIPTION OF ILLUSTRATIVE EMBODIMENTS

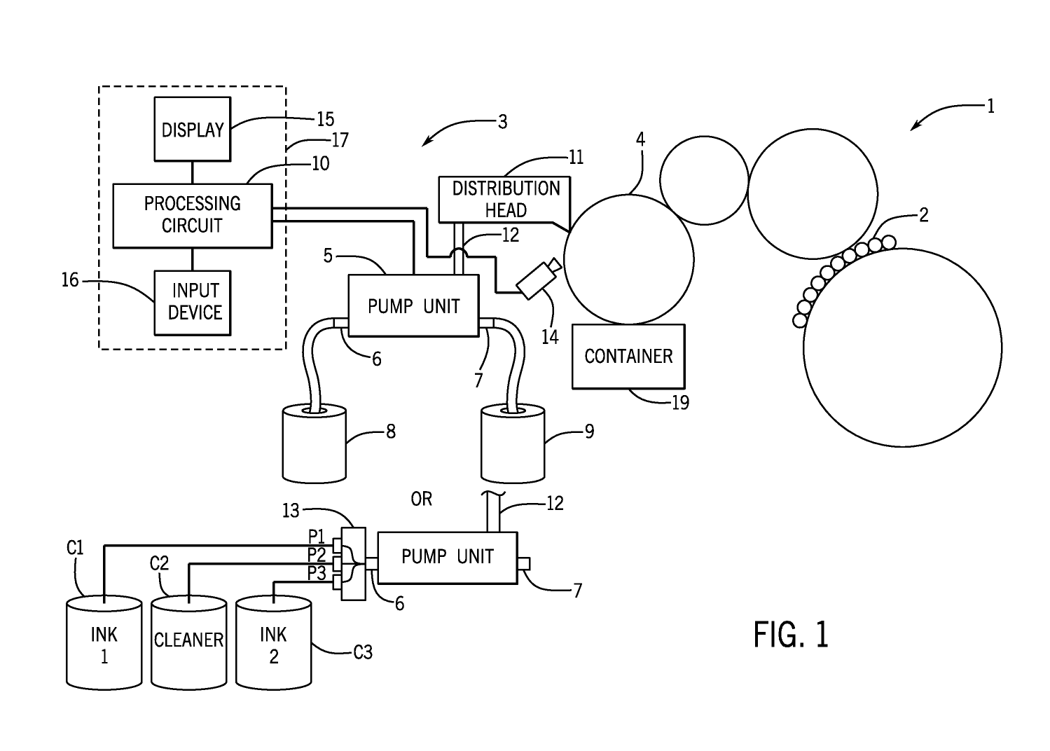

Referring now to FIG. 1, a block diagram of a printing press 1 will be described, according to an illustrative embodiment. In this embodiment, the printing press is a decorator press for printing on metal cans 2. The printing press may be any type of web offset press, sheet fed press, non-offset presses such as gravure presses, newspaper presses, etc. Press 1 comprises a digital ink supply system 3 which uses pumps under computer control to feed ink to a roller 4 of the press. The press may comprise one or more rollers in various embodiments to bring the ink to the cans 2 or other products to be printed.

In this embodiment, system 3 comprises a pump unit 5 comprising a plurality of inlet ports 6, 7, a first inlet port 6 configured to receive an ink of a first color from a first ink source 8 and a second inlet port 7 configured to receive a fluid from a second fluid source 9. Each inlet port may comprise a valve configured to open and close the port partially and/or fully, which may be manually operated by way of a handle and/or computer controlled by way of a control signal received from processing circuit 10 over a wired or wireless connection. In a computer controller embodiment, the signal is configured to control an actuator, such as a motor, to open and/or close the respective port partially and/or fully. While two ports are illustrated in this embodiment, three or more ports may be used in alternate embodiments.

Each of fluid sources 8 and 9 (or more) may comprise inks of different colors or a cleaning solution. For example, the cleaning solution may comprise a clear, pigment-free ink, a highly viscous cleaner, a less viscous cleaner, or other cleaning fluids or solutions. Fluid sources 8 and 9 may be filled with or source other fluids, such as an adhesive, a varnish, coatings, silicones, lubricants, sealers, or other fluids. Fluid source 8 and 9 may comprise a bucket or other holding tank which may be configured to hold the fluids.

In an alternative embodiment, a manifold or distributor 13 may be used to channel one of a plurality of different fluids to pump unit 5, as shown in FIG. 1. Manifold 13 may comprise any number of ports, though three ports P1, P2 and P3 are provided in this exemplary embodiment. Manifold 13 may comprise electronically controlled valves that open or close ports P1, P2, P3 as needed to channel the correct fluid from containers C1, C2, C3 to pump unit 5. Manifold 13 may be integrally formed with and/or part of pump unit 5 or be a separate device coupled to pump unit 5 with conduits.

System 3 further comprises a distribution head 11 joined to pump unit 5 by one or more fluid conduits 12. Distribution head 11 may be configured to receive fluids from pump unit 5 and provide or spread the fluids received from pump unit 5 across a print roller. Pump unit 5 and distribution head 11 may each comprise a separate enclosed housing coupled together with tubing or other conduit(s). Pump unit 5 may comprises one or more separate fluid pumps and distribution head may further comprise one distribution port or channel or conduit corresponding to each separate fluid pump. For example, each distribution port may be configured to source fluid from a corresponding positive displacement pump to a different zone of a roller on the printing press. Further, distribution ports and/or separate fluid pumps within pump unit 5 may be individually configurable by processing circuit 10 to turn on/off, operate at different speeds, etc.

A separate conduit 12 (e.g., tube, pipe, etc.) may run between each separate fluid pump to each channel within the distribution head. In one embodiment, at least four separate pumps/channels are provided. In another embodiment, at least eight separate pumps/channels are provided. In alternative embodiments, one separate pump may feed a plurality of channels or one channel may be fed by a plurality of separate pumps. Pump unit 5 may be configured for positive displacement pumping of fluids or other methods of pumping fluids.

A sensing device 14 may be coupled to the press (e.g., physically, via a bracket or other mechanical coupling) and configured to sense a characteristic of fluid flowing out of distribution head 11. Sensing device 14 may comprise a viscosity sensor, a light sensor, a color sensor, or other type of sensing device. Sensing device 14 may be configured to sense light reflecting from the ink or other fluid as the fluid flows along a portion of distribution head 11, out of distribution head 11, into a collection container 19, etc. Alternatively, sensor 14 may be housed within the housing of distribution head 14 and configured to image fluid as it flows through a channel or conduit of one of the distribution ports of head 11.

A computer controller 17 may comprise a processing circuit 10 configured to receive the sensed characteristic, compare the sensed characteristic to a predetermined threshold, and to provide an indication to a display 15 based on the comparison. Processing circuit 10 may do so under control of a programmed microprocessor or other circuit, and may do so in response to a request received from input device 10 (e.g., a keyboard, touch screen, speech recognition input, and/or mouse, etc.) or automatically without requiring user input. The indication on display 15 may comprise illuminating a light-emitting diode (in a simple form of a display), or may comprise a message in text form, color, flashing indicator on a display screen (e.g., LCD display, etc.) and may be accompanied by an audible indication provided by a speaker. In another embodiment, processing circuit 10 may be configured to monitor the sensed characteristic and, when it meets a threshold criteria, processing circuit 10 may be configured to stop or redirect the flow of ink away from a waste collection container 19. Processing circuit 10 may be configured to provide other control outputs based on the sensed characteristic. For example, processing circuit 10 may further be configured to stop the pumping operation of pump unit. In another embodiment, processing circuit 10 may further be configured to activate the decorator to begin a printing operation.

Computer controller 17 may comprise wired and/or wireless inputs and outputs for communication with and/or control of the various components described in FIG. 1

In one example, the fluid comprises an ink having a color and the sensing device is configured to sense the color or spectral response of the fluid passing out of the distribution head. The predetermined threshold may be a predetermined threshold stored in any of a number of color spaces, such as a CIE L*a*b* color space, CIELUV color space, RGB, CMYK, sRGB, etc. In one embodiment, processing circuit 10 may be configured to store a table of a plurality of color values and/or viscosities for different inks, cleaners or other fluids to be used on press 1 (e.g., three or more color values, five or more color values, etc.). Processing circuit 10 may be configured to determine if the sensed color or viscosity of the fluid sensed by sensor 14 is within a tolerance of any of the values stored in the table and, if so, provide an indication of such on display 15.

In one alternative, either of ports 6 or 7 may comprise a two-way port configured to selectively stop and allow fluid to flow in either direction.

In another alternative, the sensed characteristic of the fluid can be displayed on the display as it is monitored (e.g., received, filtered, etc.), thereby allowing an operator to decide when the second fluid has passed through sufficiently to begin the next operation.

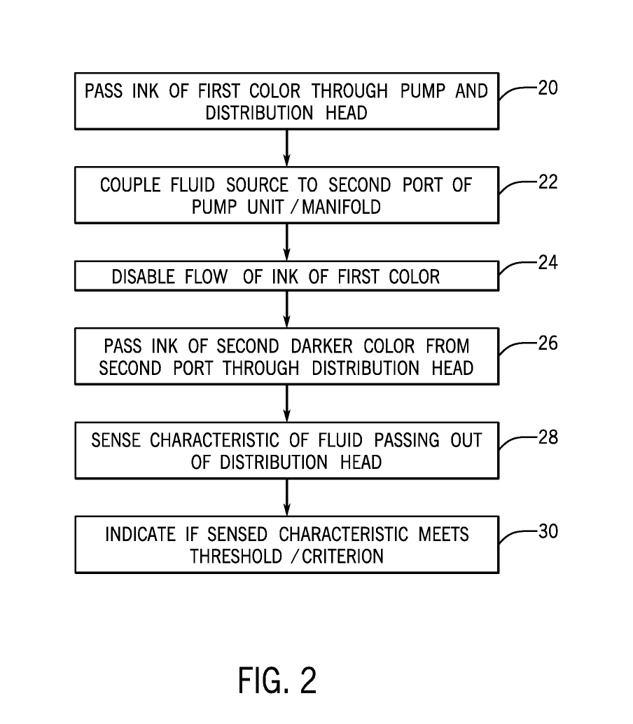

Referring now to FIG. 2, a method of rapid changeover of inks on a printing press will be described. A single printing press, such as a decorator press, may be used to print a plurality of different colors of inks. For example, a batch of metal cans (which can be associated with a certain label) may be printed with a red ink, a black ink, a white ink, and/or other inks. In some cases, the press or one or more parts of the press must be cleaned between inks during a label change. A decorator press may have different colors printed from different print cylinders disposed at different locations around a Ferris wheel-shaped or circular or curved shaped press arrangement.

In one example, a first label for a first beverage can require red, white, yellow or gold and black. A second label for a different beverage can require purple, white, orange, green 1 and green 2 (e.g., two different colors of green). During the color- or label-changeover process, the white distribution head and pump unit can remain on the press, but the red, yellow/gold and black distribution heads are to be removed, cleaned, and loaded with new ink colors, for example, orange and green 1. Further, one new color is to be added by way of an additional pump unit and distribution head (in this case, green 2). While FIG. 2 illustrates one particular method for changing inks on a printing press, modifications to this method for other applications may be made.

In this embodiment, a printing press comprises a pump unit having a plurality of ports and a distribution head. At a block 20, the method comprises passing an ink of a first color from a first port on the pump unit (or manifold) through the pump unit and through the distribution head. For example, a first ink source 8 (FIG. 1) may be coupled to pump unit 5 via port 6 and processing circuit 10 may be configured to control pump unit 5 to pump ink from the first ink source through distribution head 11 to rollers 4.

At a block 22, the method comprises coupling a fluid source having a fluid to a second port on the pump unit (which may be a port on the manifold), wherein the fluid comprises at least one of an ink of a second color and a cleaning solution. This coupling may be done manually, or electromechanically in response to a control signal from processing circuit 10 to an actuator. Block 22 may be performed while the press is still running with the ink of the first color in order to save time. Coupling may include one or more of removing a cap or plug on second port 7, attaching a conduit or tubing from source 9 to second port 7, tightening the attachment, opening a valve attached to second port 7 to enable the flow of fluid, and/or other operations.

At a block 24, the method comprises disabling the flow of ink of the first color through the pump unit and distribution head. This disabling may be done manually, or electromechanically in response to one or more control signals from processing circuit 10. Disabling the flow of ink may comprise one or more of stopping the press, stopping the pump unit, reducing the flow of ink, closing a valve attached to first port 6, removing the conduit or tubing from source 8 to first port 6, and/or other operations. In one embodiment, block 24 is done only after block 22 has been done. Alternatively, the order of any or all steps in FIG. 2 may be reversed or otherwise ordered.

At a block 26, the method comprises passing the fluid through the pump unit and distribution head. For example, processing circuit 10 may be configured to control pump unit 5 to begin pumping the fluid from source 9 through conduits within pump unit 5, through conduit(s) 12 and through distribution head 11 to roller 4.

At a block 28, the method comprises sensing a characteristic of fluid passing out of the distribution head using a sensing device. The sensing may be done with a hand-held or mobile sensor or scanner, or alternatively the sensing device may be coupled to the printing press. The sensing device may be directed at any portion of the path of the fluid as it travels through the distribution head, out of the distribution head, onto roller 4, and/or onto other rollers.

At a block 30, a signal received from the sensing device is encoded with or otherwise represents a characteristic of the fluid sensed, such as color, viscosity, or other characteristics. Processing circuit 10 is configured to receive the signal, compare the sensed characteristic to a predetermined threshold (e.g., one stored in memory, which may be a value, a tolerance around a value, etc.) and to provide an indication on a display based on the comparison.

In one embodiment, if the second ink is darker than the first ink, the second ink is passed through the pump unit 5, channels 12 and distribution head 11 to purge the first ink through the distribution head and into a suitable waste or recycling container 19 (FIG. 1). In one example, the first, lighter ink may be a yellow and/or gold ink and the second, darker ink may be a black ink. In another example, the first, lighter ink may be a yellow and/or gold ink and the second, darker ink may be a dark green link. Other ink colors are contemplated.

If the second ink is lighter than the first ink, a cleaner may be first passed through pump unit 5, channels 12 and distribution head 11 to purge the first ink through the distribution head into the recycling container 19. Once the first ink has been adequately purged and the system components adequately cleaned, the second lighter ink may be channeled through the system components for printing.

In another embodiment, an additional block may be added after block 30 to indicate that the press is ready for production by providing an indication on or near any component of the system of FIG. 1.

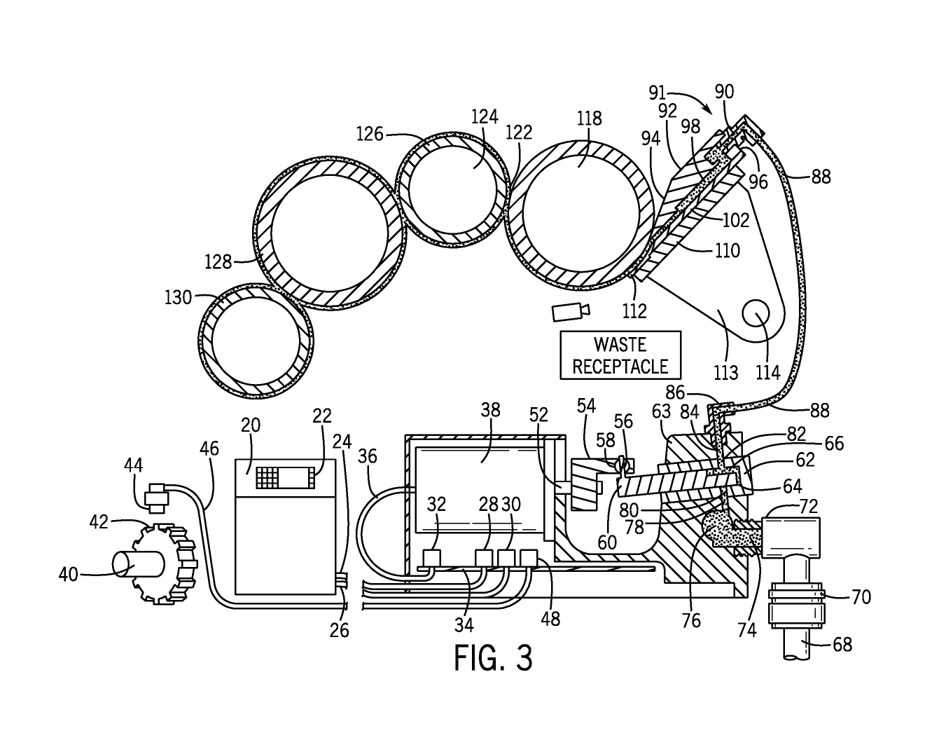

Referring now to FIG. 3, a press comprising a digital inking system will be described according to various embodiments. The press includes a computer controller, shown in this embodiment as a keyboard or control unit. The press may further include a digital ink pump assembly, a swing frame, and plural injector pumps for inking the first of several rollers placed in a series relationship. The press also includes a transfer blade and several stages of “fanning out” the ink supplied by the digital ink pumps.

A keyboard 20 may have a plurality of keys 22 thereon, the keyboard 20 capable of sending instructions from the keys through the lines 24, 26. Keyboard 20 includes keys for instructing the unit how much ink to flow, either collectively or individually. Keys may include a single key for increasing all flow, while the individual keys may permit one pump to handle more ink, while another pump less.

In an alternate embodiment, the computer controller may comprise an operator control unit running graphical user interface software on a touch screen to allow a user to control different ink keys or zones and different color distribution head/pump arrangements pursuant to operator inputs, preprogrammed controls, or other control programs.

The instructions sent by the keys are forwarded along lines 24, 26 to keyboard elements 28, 30. Here, the messages are forwarded from the individual elements 28, 30 to a plurality of output drivers 32 contained on a circuit board 34. Each driver is connected, as by a line 36, to an armature of an individual ink pump 38. Although one pump is shown for clarity, there may be eight such ink pumps in each array of digital pumps, or any other number of pumps.

In addition to the control achieved by the individual pumps, cumulative control is achieved by a line shaft 40 which contains a toothed wheel 42. As the line shaft rotates, (at whatever speed) this wheel 42 sends a digital signal picked up by the detector 44 and sent along the lines 46 to drive element 48. The clocking pulse therefore comes from the line shaft, and the individual pulses come from the individual pumps. In this way, the ink is delivered to the rollers. The keyboard thus controls the output of each pump relative to another, and the line shaft 40 and its associated gears 42, 44 controls the speed at which the ink pumps are ultimately operated. The line shaft may be attached to the press, for example at one of the rollers, so that press line speed correlates with ink pump speed.

The armature 38 of the drive motor, when actuated, turns a rotary shaft 52. The crank pin 54 is driven at a speed which is equal to the speed of the shaft. A carrier bearing 56 is adapted to receive a drive pin 58 from the piston pump 60. The piston pump 60 rotates, and because of its inclination and because its drive link portion is offset from the axis of the piston, as the piston moves in and out, relative to its housing 62, it pumps fluid therefrom.

A plurality of individual pumps 60 may be arrayed together within a single housing 62, and a drive motor 38 may be provided for each of the pumps. The motors for the pumps may be stepper motors, or another type of motor. In the arrangement shown, a digital control circuit provides timed output pulses, and each output pulse results in a very small step of the motor, which may require 200 to 400 steps per revolution in an exemplary embodiment. The digital pulse train thus controls the power supplied to the motors and provides communications or instructions, while the line shaft component, which advises the microcomputers of the press speed, regulates the speed and hence the overall output rate of all the pumps.

Piston 60 includes a solid portion 64 and a cutaway relief portion 66. As the pump rotates, the rotation and reciprocation of the piston causes ink flow in the system, as follows. The ink is drawn up from a master supply 68 through a fitting 70 and then to the through opening 72 leading into a longitudinal gallery 74 which extends the length of the block containing the cylinders. The main ink flow for each piston 60 is through an individual inlet for each piston 60, with the ink 78 being drawn into the inlet area 80 of the pump as the piston 60 is withdrawn. Shortly thereafter, the outlet port 82 comes into registry with the relieved portion 66, causing the ink 84 to flow from there through a fitting 86 and out the outlet 88.

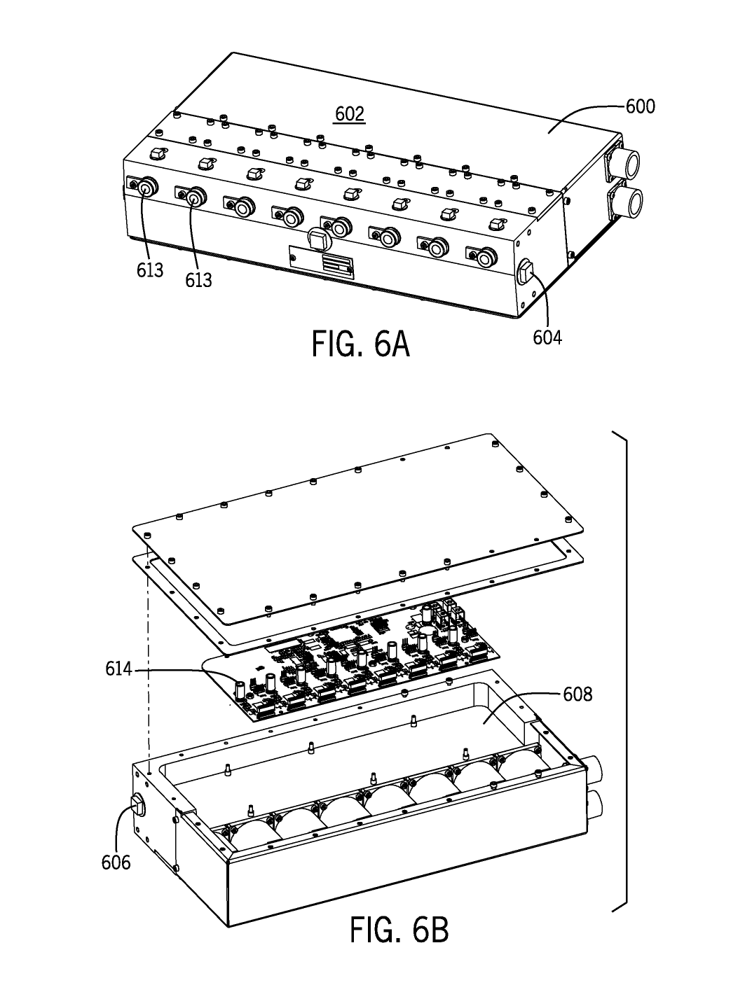

From here, the ink proceeds into a fitting 90, and there the ink passes to the distribution head 91, which will now be described. The distribution head comprises a main body portion 92 in which the fitting 90 is received. The exterior of the distribution head includes an exterior surface 94 with a slight slope to it. The rear surface 96 is substantially flat. The bottom includes a main portion or conduit 98 for ink, most of which conduit is of a relatively small width, while the balance of the ink channel terminates in a spreader or fan-out position 100. The remainder is flat, as at 97, so as to mate with the blade holder 102. Hence, ink that is trapped in this area must be spread or fanned out and assume the position of FIG. 5.

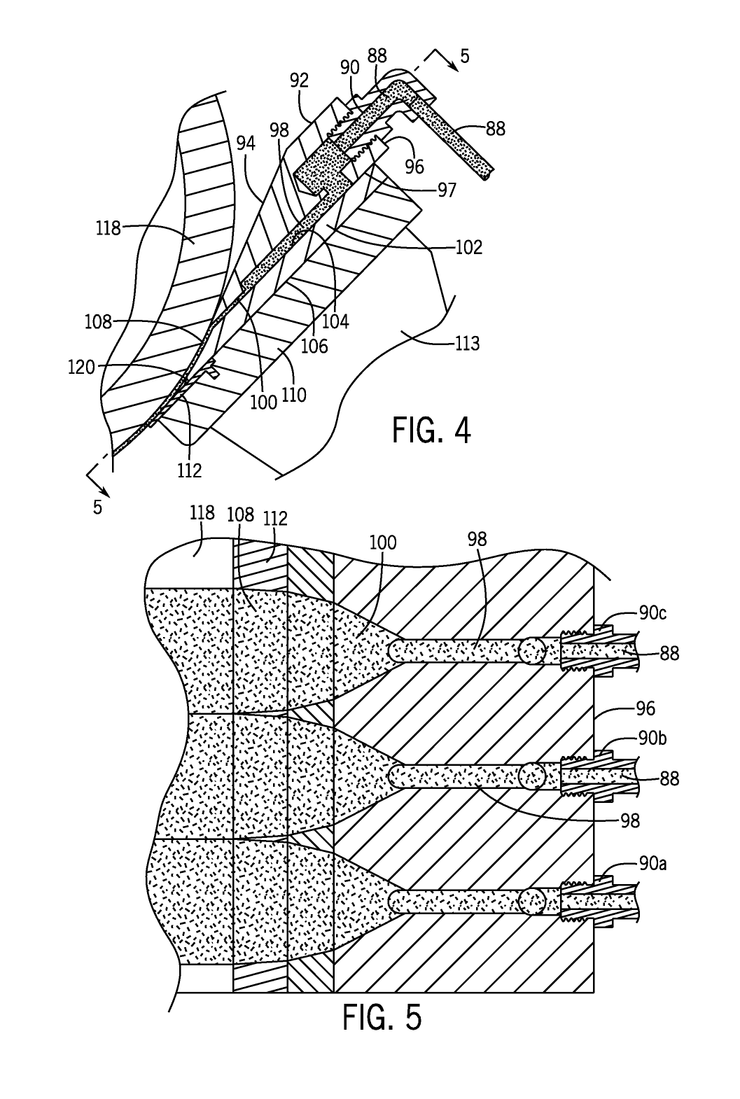

Referring to FIG. 4, beneath the body portion 92 containing the ink is a blade holder unit 102. This unit has an upper, flat portion 104, a lower flat portion 106, and a front portion 108 that is tapered to approximately the same extent as its counterpart 94. A blade support 110 lies beneath the blade holder 102, and contains a notch, of greater or less length, for holding a blade 112. The blade support 110 is formed separately from, or as a part of the swing frame 112, which pivots about point 114 (FIG. 3).

For each of the digital ink pumps delivering a charge of ink, (which may be in varying quantities), the first roller in the sequence, i.e., the fountain roller 118 contacts and picks up a supply of ink. This roller 118 is spaced from the blade and the blade support by a working distance or clearance 120. The next roller is spaced by a working clearance 122 (FIG. 3) that lies between a micrometric roller 124 and the fountain roller 118. This micrometric roller 124, which may contain a knurled surface 126, operates at web speed, whereas the roller 118 operates at a lower speed, in this exemplary embodiment. The web speed or transfer roller 128 is normally made from a rubber material, and this transfer roller 128 operates also at web speed. Attached to the transfer roller is the oscillating roller 130. Other rollers may be provided.

By referring to FIGS. 4 and 5, the operation can be more clearly viewed. The ink is shown to be spread from its region of concentration 90, 90a, 90b, etc. to an area in which it is dispersed, finally reaching a tangent point to that of an adjacent discharge. The blade does not move, but serves to spread or transfer the ink evenly, to the extent this has not been done already.

With the digital pumps set to self-adjust to the new ink flow requirement on a column-by-column basis, this occurs constantly as press speed varies. Press speed information is “broadcast” to each page pack, allowing this adjustment to be performed thousands of times each second providing improved accuracy. In a condition where little or no ink is required, the blade may still be maintained at a constant distance from the roller, but the pump supplies no ink and consequently, the zone is empty.

In one embodiment, there may be no physical or mechanical connection between the press and the digital ink supply system. In alternate embodiments, one or more components of the digital ink supply system may be coupled to components of the press, such as a housing or mounting bracket.

The pump units may be purged of the color very rapidly. A swing frame 113 may be taken back into its non-operating position and the ink may be rapidly purged by running through the pumping cycle a number of times. Thus, a high speed purge may be made of all of the ink pumps, without having to disconnect anything from the press. This can provide much faster color changes.

The density, and all adjustments, may be made from the keyboard or console 20.

Control of ink put on the paper may be achieved volumetrically. In one embodiment, the digital inking system may add a certain, fixed amount of ink with each revolution of the roller, and no water may be fed back.

The digital inking system may be retrofitted to existing presses. For example, for a press which is equipped with an ink bath or similar type arrangement, the swing frame 113, which pivots about 114, may be withdrawn and removed in order to use the ink bath.

In some embodiments, there may be one of these pump units for every color of ink used in the press. This could be advantageous in a four, five or six color press. In one example, everything back of the rollers could be replaced in the depiction of FIG. 3. Of course, the pivot pin and the swing frame portion per se of the press need not be replaced in total, assuming that the portion from the blade support on were replaced.

In various embodiments, a keyboard can be placed next to the digital inking system, or it can be centralized at a console. The option of having both the keyboard and a console offers options in press ink and water control.

Regarding options available with the system, it is possible to allow the console to measure ink usage. In fact, this may be done all the way down to the per column level. This makes it possible to track consumables down to a fine degree. The optional press controls can provide features such as a noise immune fiber optic communication at high speed.

The keyboards may be “smart” and may remember (by storing in a memory coupled to processing circuit 10) their last settings. Accordingly, if there is a power failure, the correct settings will not be affected.

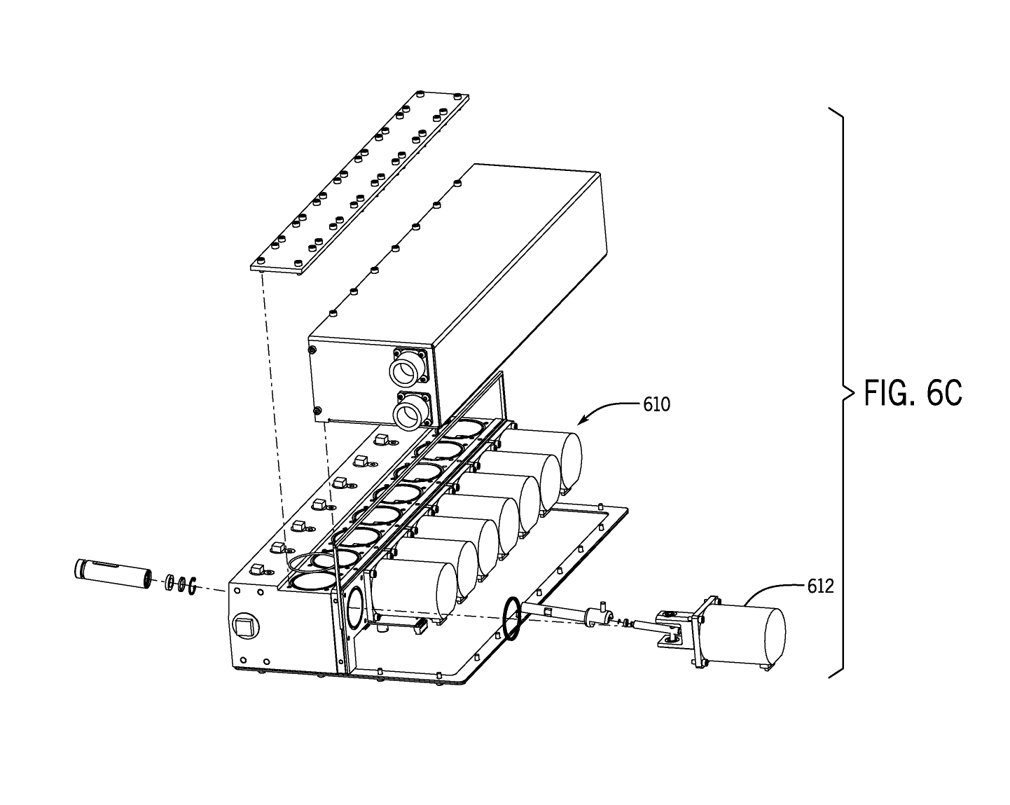

Referring now to FIG. 6A-6C, there are several views of another exemplary pump unit 600. Pump unit 600 comprises a housing 602. Pump unit 600 has a first fluid input port 604 and a second fluid input port 606 (FIG. 6B). Both fluid input ports 606 and 604 provide access to an ink chamber or billet 608 accessible by the plurality of pumps 610. Each pump has a respective motor (e.g., motor 612) configured for positive displacement pumping. A circuit board 614 (FIG. 6B) may also be housed for powering the pumps and receiving and processing control signals received from processing circuit 10 (FIG. 1). In one embodiment, each stepper motor may be controlled by a separate microprocessor.

In operation, ink is sourced through one of ports 604, 606 to chamber 608. Pumps control the flow of ink from chamber 608 to individual output ports 613 which are coupled to distribution head 11 (not shown).

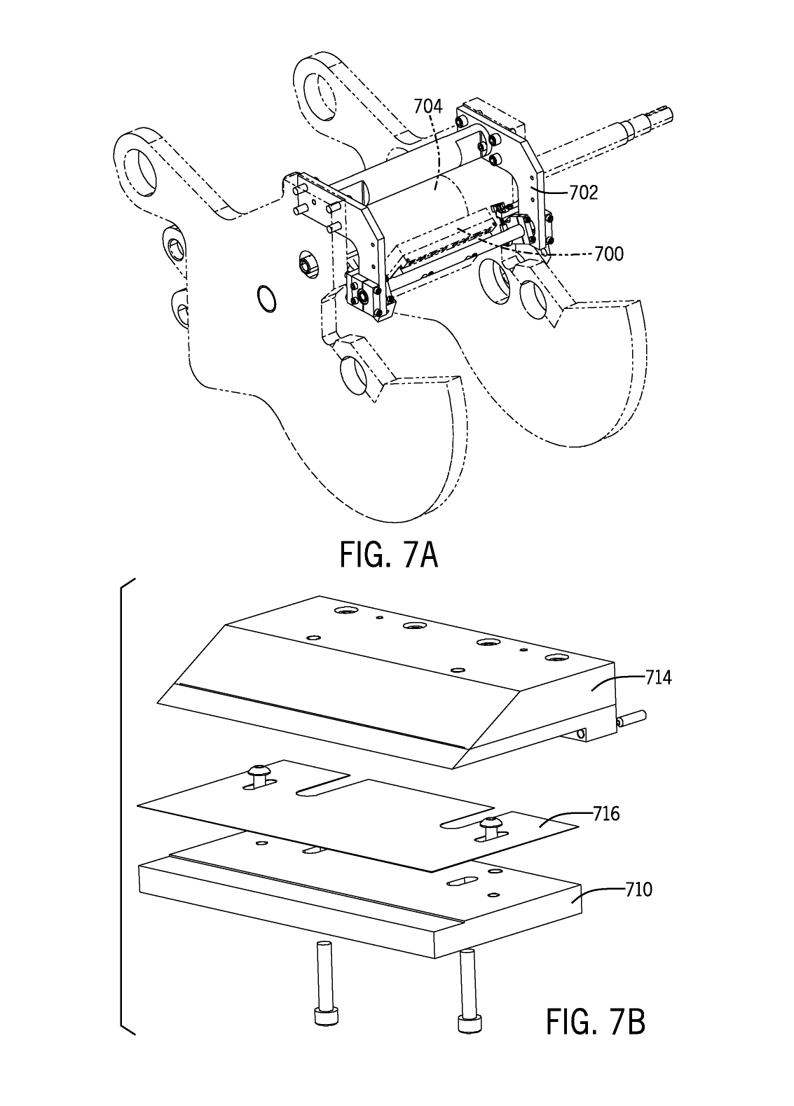

Referring now to FIG. 7A and 7B, FIG. 7A illustrates an exemplary distribution head 700 mounted to a bracket 702 of a swing frame assembly of a printing press. The swing frame assembly is mounted such that the distribution head is at a predetermined angle and distance from the roller 4. The swing frame assembly can be swung back to simplify cleaning the pump unit 5, channels 12 and distribution head 11. The press has a roller 704 which is inked by the distribution head, which sources ink from the pump unit of FIGS. 6A-6B. In FIG. 7B, distribution head 700 is shown in an exploded view, showing a base part 710, a wiper blade 716 and an angled top part 714. Blade 716 is disposed within a small gap of roller 704 and provides a controlled ink film thickness, thereby limiting the thickness of ink applied to the roller 4.

While many embodiments described in the present disclosure describe the process of switching from ink of a first color to a second color, the systems and methods described herein may be applicable for a process of switching from a first ink in a first tank to a second ink, of the same color as the first ink, in a second tank. In such an embodiment, the sensing device of the printing press may be an ink level sensor, configured to sense the ink level in a tank housing the first ink. The sensed characteristic is the level of the first ink in the tank, and may be compared to a predetermined ink level threshold. The printing press may then be configured to switch from using the first ink in the first tank to the second ink in the second tank if the ink level in the first tank is running low. In some embodiments, an indication of the ink level in the first tank may be provided on a display, and the printing press may receive a user input indicating a switch to the second tank. In some embodiments, the printing press may automatically switch to using the second tank when the ink level in the first tank reaches the threshold.

According to various exemplary embodiments, processing circuit 10 may comprise a memory, a local cache, a local hard disk drive, a CD-ROM, a floppy disk, a random access data source (e.g., a RAM), a read-only data source (e.g., a ROM), an Ethernet port, a communication port, or any other volatile or non-volatile memory. According to various exemplary embodiments, processing circuit 10 may be any processing circuit of past, present, or future design that is capable of carrying out the processes described herein. Processing circuit 10 may comprise analog and/or digital components, such as a microprocessor, microcontroller, application-specific integrated circuit (ASIC), field-programmable gate array (FPGA), or other electronic, mechanical, or electromechanical components, as well as any computer-readable code or software operable therewith or thereon, configured to perform the functions described herein and other known functions.

1. A method of changing inks in a printing press, the printing press comprising a pump unit having a plurality of ports and a distribution head, the method comprising:
passing an ink of a first color from a first port on the pump unit through the pump unit and through the distribution head;
coupling a fluid source having a fluid to a second port on the pump unit, wherein the fluid comprises an ink of a second color darker than the first color;
disabling the flow of ink of the first color through the pump unit and distribution head;
passing the fluid through the pump unit and distribution head;
sensing a characteristic of fluid passing out of the distribution head using a sensing device;
comparing the sensed characteristic to a predetermined threshold; and
providing an indication on a display based on the comparison.

2. The method of claim 1, wherein the printing press is a decorator press for printing on metal cans.

3. The method of claim 2, wherein the pump unit is configured for positive displacement pumping of fluids.

4. The method of claim 3, wherein the pump unit has at least four separate positive displacement pumps.

5. The method of claim 4, wherein the distribution head comprises at least four separate distribution ports, each distribution port configured to source fluid from a corresponding positive displacement pump to different zones of a roller on the printing press.

6. The method of claim 5, wherein the sensing device comprises a viscosity sensor coupled to the printing press.

7. The method of claim 1, wherein the sensing device is configured to sense a color of the fluid passing out of the distribution head, wherein the indication is provided on the display when the comparing step indicates the fluid passing out of the distribution head meets a predetermined color threshold.

8. The method of claim 7, wherein the predetermined color threshold is stored in CIE L*a*b* color space.

9. The method of claim 1, wherein the pump unit and distribution head each comprise a separate housing coupled together with tubing.

10. The method of claim 1, wherein the plurality of ports are disposed on a manifold portion of the pump unit.

11. The method of claim 1, wherein the first color and the second color are the same color, the sensing device is configured to sense the levels of the first ink in a first tank, the sensed characteristic is the level of the first ink in the tank, and the comparison comprises comparing the level of the first ink in the tank to a predetermined threshold;
wherein the method comprises providing an indication of the level of the first ink in the tank on the display.

12. A decorator press for printing on metal cans, comprising
a pump unit comprising a plurality of inlet ports, a first inlet port configured to receive an ink of a first color from a first ink source and a second inlet port configured to receive an ink of a second color darker than the first color;
a distribution head coupled to the pump unit and configured to spread fluid received from the pump unit across zones of a print roller;
a sensing device coupled to the press and configured to sense a characteristic of fluid flowing out of the distribution head; and
a processing circuit configured to receive the sensed characteristic, compare the sensed characteristic to a predetermined threshold, and to provide an indication to a display based on the comparison.

13. The decorator press of claim 12, wherein the pump unit is configured for positive displacement pumping of fluids.

14. The decorator press of claim 13, wherein the pump unit has at least four separate positive displacement pumps.

15. The decorator press of claim 14, wherein the distribution head comprises at least four separate distribution ports, each distribution port configured to source fluid from a corresponding positive displacement pump to a different zone of a roller on the printing press.

16. The decorator press of claim 15, wherein the sensing device comprises a viscosity sensor coupled to the printing press in a position configured to sense the characteristic of fluid flowing out of the distribution head.

17. The decorator press of claim 16, wherein the sensing device is configured to sense a color of the fluid passing out of the distribution head, wherein the indication is provided on the display when the comparing step indicates the fluid passing out of the distribution head meets a predetermined color threshold.

18. The decorator press of claim 17, wherein the predetermined color threshold is stored in CIE L*a*b* color space.

19. The decorator press of claim 12, wherein the pump unit and distribution head each comprise a separate enclosed housing coupled together with tubing.

20. The decorator press of claim 12, wherein the first and second ports are disposed on a manifold integrally formed with the pump unit.
